(19) United States
(12) Patent Application Publication
(10) Pub. No.: US 2017/0155543 A1
(43) Pub. Date: Jun. 1, 2017

(54) CONTROL APPARATUS, COMMUNICATION SYSTEM, AND CONTROL METHOD

(71) Applicant: NEC CORPORATION, Tokyo (JP)

(72) Inventor: Eiichi ISHIZUKA, Tokyo (JP)

(73) Assignee: NEC CORPORATION, Tokyo (JP)

(21) Appl. No.: 15/353,149

(22) Filed: Nov. 16, 2016

(30) Foreign Application Priority Data
Nov. 30, 2015 (JP) 2015-233170

(51) Int. Cl. H04L 12/24; H04L 12/801

(52) U.S. Cl. CPC H04L 41/0654; H04L 47/10; H04L 41/12

(57) ABSTRACT

A control apparatus is a control apparatus capable of controlling a plurality of relay apparatuses capable of executing a process for a packet, the control apparatus including: a first unit that determines presence of a predetermined relay apparatus in a state incommunicable with all neighboring relay apparatuses; a second unit that calculates a communication path bypassing the predetermined relay apparatus as a communication path for the packet, when it is determined that the predetermined relay apparatus is present; and a third unit that notifies at least one of the plurality of relay apparatuses of a processing rule for achieving the calculated communication path.

This application is based upon and claims the benefit of priority from Japanese Patent Application No. 2015-233170, filed on Nov. 30, 2015, the disclosure of which is incorporated herein in its entirety by reference.

### TECHNICAL FIELD

The present invention relates to a control apparatus, a communication system, a control method, and a program.

### BACKGROUND ART

A relay apparatus in a packet communication network includes a forwarding table to determine a process for a received packet. For example, a technique referred to as OpenFlow has been recently proposed, as indicated in NPL 1 (ONF (Open Networking Foundation), “Software-Defined Networking: The New Norm for Networks” April. 2012) and NPL 2 (ONF (Open Networking Foundation), “OpenFlow Switch Specification Ver.1.3.4 (Protocol version 0x04)”).

In the OpenFlow, a packet forwarding function and a path control function are separated in accordance with a flow control protocol, and an OpenFlow controller (hereinafter, referred to as a control apparatus) performs control and management over different types of OpenFlow switches (hereinafter, referred to as relay apparatuses), using a unified application program interface (API).

In addition, in the OpenFlow, packet control is performed for each flow used as a granularity of the control, in order to achieve a high speed data path and to reduce cost for the control.

A relay apparatus described in each of NPL 1 and NPL 2 includes a flow table that includes a flow entry defining a process for a received packet. The relay apparatus classifies types of packets depending on a combination of a plurality of types of tuples, such as a media access control (MAC) address and an internet protocol (IP) address in Ethernet®. In the OpenFlow technique, a plurality of packets (packet group) classified as an identical type is referred to as a flow. The relay apparatus can define a process of designation of an output port, header rewriting, and the like for packets included in each flow, as a flow entry included in a flow table.

Setting of a flow entry in a relay apparatus is performed via a control apparatus, a switch-specific command line interface (CLI), and the like. When the control apparatus sets a flow entry, the setting is performed by means of a FlowMod message of an OpenFlow protocol exchanged via a secure channel (open flow channel) between the relay apparatus and the control apparatus. The relay apparatus operates in accordance with a flow table in which addition or rewriting is instructed as appropriate from the control apparatus via the secure channel.

Herein, in a centralized management architecture such as the OpenFlow described in NPL 1 and NPL 2, communication paths in a network constituted of a group of mutually connected relay apparatuses are centralizedly managed by a control apparatus. A system is disclosed in which the control apparatus performs control and management of user data and control data separately to appropriately forward a packet of the user data. In such a case, when a relay apparatus used in a communication path through which user traffic flows becomes unusable due to an unexpected failure and the like, the control apparatus needs to recalculate a bypass path and perform deletion of path information and resetting of bypass path information for each relay apparatus.

However, in the system, since the relay apparatus that becomes unusable is unable to respond to the control apparatus, the control apparatus cannot determine a status of the relay apparatus, failing to complete a process of updating path information. Consequently, the control apparatus cannot complete the update process until waiting for a response from the relay apparatus is timed out. Accordingly, this causes a problem that communication of user traffic breaks down during a period from when the relay apparatus becomes unusable to when update of path information is completed.

### SUMMARY

In light of the above-described problem, an example object of the invention is to provide a control apparatus, a communication system, and a control method, capable of shortening a communication breakdown time generated when a relay apparatus becomes unusable.

A control apparatus according to an example aspect of the invention is a control apparatus capable of controlling a plurality of relay apparatuses capable of executing a process for a packet, wherein the control apparatus includes: a first unit that determines presence of a predetermined relay apparatus in a state incommunicable with all neighboring relay apparatuses; a second unit that calculates a communication path bypassing the predetermined relay apparatus as a communication path for the packet, when it is determined that the predetermined relay apparatus is present; and a third unit that notifies at least one of the plurality of relay apparatuses of a processing rule for achieving the calculated communication path.

A communication system according to an example aspect of the invention includes: a plurality of relay apparatuses executing a process for a packet; and a control apparatus capable of controlling the relay apparatuses, wherein the control apparatus includes: a first unit that determines presence of a predetermined relay apparatus in a state of communication breakdown with all neighboring relay apparatuses; a second unit that calculates a communication path bypassing the predetermined relay apparatus as a communication path for the packet, when it is determined that the relay apparatus is present; and a third unit that notifies at least one of the plurality of relay apparatuses of a processing rule for achieving the calculated communication path.

A control method according to an example aspect of the invention is a control method for a control apparatus capable of controlling a plurality of relay apparatuses executing a process for a packet, the control method including the steps of: determining presence of a predetermined relay apparatus in a state incommunicable with all neighboring relay apparatuses; calculating a communication path bypassing the predetermined relay apparatus as a communication path for the packet, when it is determined that the predetermined relay apparatus is present; and notifying at least one of the plurality of relay apparatuses of a processing rule for achieving the calculated communication path.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration example of an operation environment according to a first example embodiment of the present invention;

FIG. 2 is a block diagram illustrating a configuration example of a control apparatus according to the first example embodiment of the present invention;

FIG. 3 is a sequence diagram illustrating an operation example in the operation environment according to the first example embodiment of the present invention;

FIG. 4 is a sequence diagram illustrating an operation example in the control apparatus according to the first example embodiment of the present invention;

FIG. 5 is a sequence diagram illustrating an operation example in the control apparatus according to the first example embodiment of the present invention;

FIG. 6 is a block diagram illustrating a configuration example of a control apparatus according to a second example embodiment of the present invention;

FIG. 7 is a block diagram illustrating a different configuration example of the control apparatus according to the second example embodiment of the present invention;

FIG. 8 is a flowchart illustrating an operation example of the control apparatus according to the second example embodiment of the present invention; and

FIG. 9 is a block diagram illustrating another configuration example of the control apparatus according to the present example embodiment.

### DESCRIPTION OF EMBODIMENTS

### Example Embodiment

### First Example Embodiment

[Description of Configuration]

A first example embodiment of the present invention is described in detail with reference to the drawings.

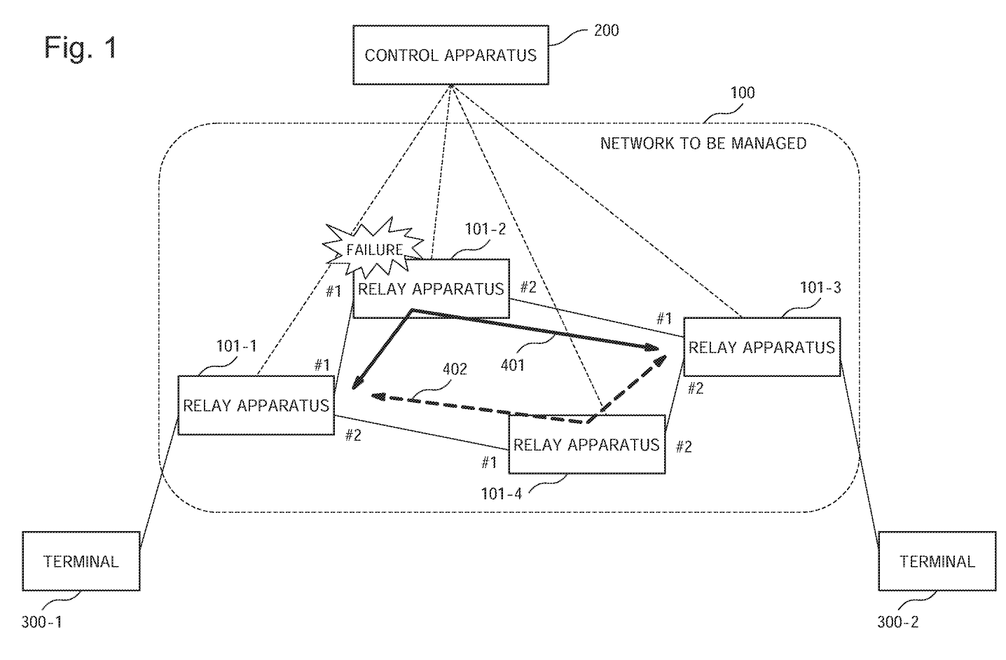

FIG. 1 is a configuration example of an operation environment according to the first example embodiment. The operation environment according to the first example embodiment is, for example, an OpenFlow network. Note that the operation environment according to the first example embodiment may be any network as long as it is a type of centralized management network, without limitation to the OpenFlow network. Hereinafter, description is given taking the OpenFlow network as an example.

As illustrated in FIG. 1, the OpenFlow network includes a control apparatus 200, a network to be managed 100 including relay apparatuses 101-1, 101-2, 101-3, 101-4, and terminals 300-1, 300-2.

In the OpenFlow network, a mechanism of a relay apparatus 101 is separated into the control apparatus 200, which is a module capable of changing a process of determining a path by external programming, and the relay apparatuses 101, each of which is a module for exclusively performing a packet forwarding process. Between the control apparatus 200 and each of the relay apparatuses 101, a secure channel (open flow channel) for communication is provided. The secure channel is used when, for example, the control apparatus 200 registers a flow entry with a flow table of a relay apparatus 101 and when a relay apparatus 101 inquires of the control apparatus 200 about a flow entry that is absent in the flow table.

The relay apparatus in the OpenFlow network refers to an edge switch and a core switch that form the OpenFlow network and that are under control of the control apparatus 200. In the OpenFlow network, the control apparatus 200 operates the flow table of each of the relay apparatuses 101 via the secure channel, thereby controlling a behavior of the relay apparatus 101.

Each of the relay apparatuses 101 holds at least one flow table. The control apparatus 200 holds all flow tables of the same contents as the flow tables of the respective relay apparatuses 101 under control. Note that the expression “hold a flow table” indicates that the flow table is under management. As long as the flow table is manageable via the network or the like, the flow table may not necessarily be actually inside the own apparatus. For example, it is conceivable that the control apparatus 200 and the relay apparatus 101 share the same flow table existing on the network.

The flow table refers to a table with which a flow entry is registered, the flow entry defining a predetermined action to be performed for a packet (communication data) matching with a predetermined rule.

The relay apparatus 101 processes a packet matching with a content written in a column for rule, in accordance with a content written in a column for action. The control apparatus 200 registers such a flow entry in the relay apparatus 101, thereby enabling control of a process for a matching packet.

Upon arrival of a packet, the relay apparatus 101 reads header information (such as transmission-source information and transmission-destination information) of the packet, and searches for a flow entry that has a matching rule (hereinafter, referred to as a matching flow entry) from the own flow table. When a matching flow entry is found as a result of the search, the relay apparatus 101 processes the packet in a manner as described in an action of the flow entry. Note that when a plurality of flow entries is found, the relay apparatus 101 processes the packet in accordance with a flow entry with a highest priority among the found flow entries. In addition, when a matching flow entry is not found as a result of the search, the relay apparatus 101 determines the packet as being a “first packet”, and inquires of the control apparatus 200 via the secure channel about how to process the packet, by forwarding a copy of the packet to the control apparatus 200. The relay apparatus 101 processes the packet and subsequent packets of the same flow in accordance with a new flow entry additionally registered by the control apparatus 200.

The control apparatus 200 communicates with the relay apparatuses 101 via the secure channels, and centralizedly manages pieces of path information of the relay apparatuses 101 in the network to be managed 100. When receiving an inquiry from one of the relay apparatuses 101, the control apparatus 200 calculates a path for forwarding the inquired packet to a transmission destination. In addition, the control apparatus 200 additionally registers, via the secure channel, a new flow entry for configuring the calculated path with the flow table of the relay apparatus 101. At this time, the control apparatus 200 also additionally resisters the same new flow entry with the own flow table.

The terminals 300 transmit and receive a packet included in a flow to and from each other via the network constituted of the relay apparatuses 101. The flow refers to, for example, a plurality of packets (packet group) classified as an identical type.

Note that the example in FIG. 1 includes four relay apparatuses 101 and two terminals 300. However, there may be any number of the relay apparatuses 101 and any number of the terminals 300, without limitation to the above-described numbers. In addition, a topology of the network may have any shape such as a tandem, tree, ring, or mesh shape, without limitation to FIG. 1.

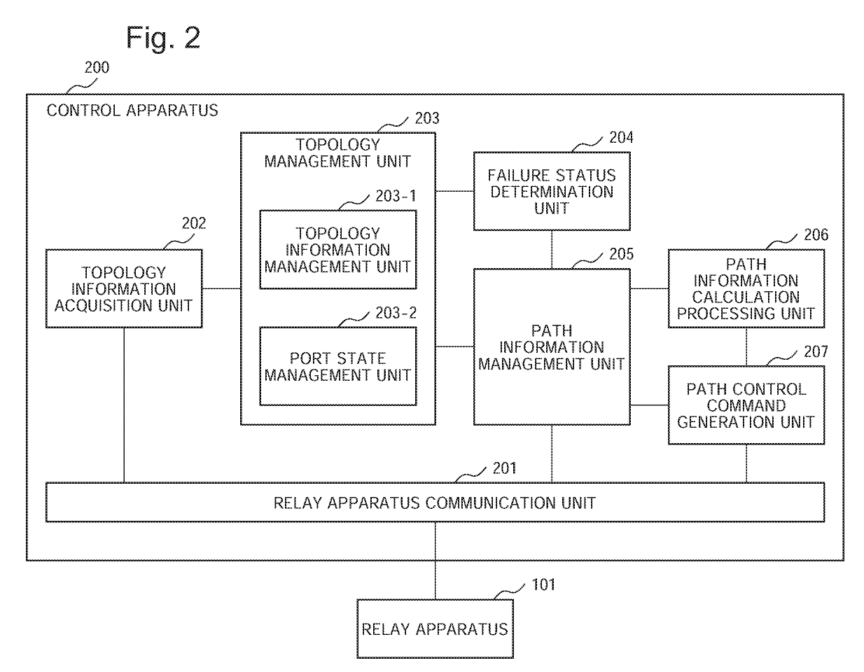

FIG. 2 is a diagram illustrating a configuration example of the control apparatus 200 according to the first example embodiment of the present invention. The control apparatus 200 includes a relay apparatus communication unit 201, a topology information acquisition unit 202, a topology management unit 203, a failure status determination unit 204, a path information management unit 205, a path information calculation processing unit 206, and a path control command generation unit 207.

Note that each of solid lines linking the components 201 through 207 in FIG. 2 indicates a relationship capable of logical communication and calling. Implementation of the components 201 through 207 in the present invention is not limited to the configuration and the network in this shape of connection.

The relay apparatus communication unit 201 performs establishment of a session for control and transmission and reception of a command for control for each of the relay apparatuses 101 connected in the network to be managed 100, via a secure channel. In addition, the relay apparatus communication unit 201 may acquire topology information from each of the relay apparatuses 101 via a secure channel.

The relay apparatus communication unit 201 receives, for example, an inquiry about a packet process from the relay apparatus 101, and forwards the inquiry to the path information management unit 205. When there is a description of the packet process in a flow table of the path information management unit 205, for example, the relay apparatus communication unit 201 forwards information about the packet process described in the flow table of the path information management unit 205 to the relay apparatus 101.

The relay apparatus communication unit 201 receives, for example, from the relay apparatus 101, a notification of a port that becomes unusable (a down port notification) among ports of the relay apparatuses 101. The relay apparatus communication unit 201 forwards, for example, the down port notification to the topology information acquisition unit 202.

The relay apparatus communication unit 201 receives, for example, from the topology information acquisition unit 202, a request for topology information indicating a connection relationship among the relay apparatuses 101 in the network to be managed 100 and for port information indicating an UP/DOWN state of each of the ports in the network to be managed 100, and forwards the request to the relay apparatus 101.

The relay apparatus communication unit 201 receives, for example, topology information and port state information of the relay apparatus 101 in the network to be managed 100. The relay apparatus communication unit 201 forwards, for example, the topology information and the port state information to the topology information acquisition unit 202.

The relay apparatus communication unit 201 receives, for example, a notification of deletion of path information relating to a down port from the path information management unit 205, and forwards the notification to the relay apparatus 101. The relay apparatus communication unit 201 receives, for example, a notification of deletion completion of the path information relating to the down port from the relay apparatus 101, and forwards the notification to the path information management unit 205.

The relay apparatus communication unit 201 receives, for example, a path control command generated by the path control command generation unit 207, generates a forward entry (flow entry) for appropriately delivering a unicast packet, a broadcast packet, and the like to a forwarding table, and forwards the forward entry to the relay apparatus 101. Note that generation of a forward entry is performed not only by the relay apparatus communication unit 201, but may be performed by the path control command generation unit 207 and the path information management unit 205.

The relay apparatus communication unit 201 receives, for example, a notification of setting completion of the forward entry from the relay apparatus 101, and forwards the notification to the path information management unit 205.

The topology information acquisition unit 202 acquires topology information of the network to be managed 100 via the relay apparatus communication unit 201, and notifies the topology management unit 203 of the topology information. The topology information includes, for example, topology information indicating a connection relationship among the relay apparatuses 101 included in the network to be managed 100, and port information indicating an UP/DOWN state of each of the ports in the network to be managed 100.

Note that the topology information acquisition unit 202 may regularly detect and acquire information among neighboring relay apparatuses by using, for example, a link layer discovery protocol (LLDP) protocol, and may irregularly notify the relay apparatus 101 and acquire the information.

The topology management unit 203 includes a topology information management unit 203-1 and a port state management unit 203-2. The topology management unit 203 receives, from the topology information acquisition unit 202, topology information indicating a connection relationship among the relay apparatuses 101 in the network to be managed 100 and port information indicating an UP/DOWN state of each of the ports in the network to be managed 100, and stores and manages the topology information and the port information.

The topology information management unit 203-1 stores and manages, for example, topology information indicating a connection relationship among the relay apparatuses 101 in the network to be managed 100. After acquiring new topology information, for example, the topology information management unit 203-1 forwards the new topology information to the failure status determination unit 204. In addition, when being notified from the path information management unit 205 of a request for forwarding topology information, for example, the topology information management unit 203-1 may forward topology information that the topology information management unit 203-1 possesses at a point of time when being notified of the request. When receiving new topology information relating to a relay apparatus of which topology information has been acquired in advance, for example, the topology information management unit 203-1 may store and manage the new topology information after deleting the past topology information. In addition, when receiving new topology information relating to a relay apparatus of which topology information has been acquired in advance, the topology information management unit 203-1 may store and manage the received topology information in association with a date of update.

The port state management unit 203-2 stores and manages, for example, port state information of the relay apparatus 101 in the network to be managed 100. After acquiring new port information, for example, the port state management unit 203-2 forwards the new port information to the failure status determination unit 204. When receiving new port state information relating to a relay apparatus of which port state information has been acquired in advance, for example, the port state management unit 203-2 may store and manage the new port state information after deleting the past port state information. In addition, when receiving new port state information relating to a relay apparatus of which port state information has been acquired in advance, the port state management unit 203-2 may store and manage the received port state information in association with a date of update.

The failure status determination unit 204 determines whether an unusable relay apparatus 101 is present. The failure status determination unit 204 references, for example, topology information forwarded from the topology information management unit 203-1 and port state information forwarded from the port state management unit 203-2, and determines presence of a relay apparatus 101 neighboring relay apparatuses whose ports are all in a down state. When a relay apparatus 101 pertaining to the condition is present, the failure status determination unit 204 determines the relay apparatus 101 as being an unusable relay apparatus, and notifies the path information management unit 205 of a fact that the relay apparatus 101 is unusable.

The path information management unit 205 determines whether a process of updating path information is necessary. In response to an inquiry about a packet process from the relay apparatus 101, for example, when there is a description of the packet process in the own flow table, the path information management unit 205 forwards information about the packet process to the relay apparatus 101 via the relay apparatus communication unit 201. When there is no description of the packet process in the own flow table, for example, the path information management unit 205 notifies the path information calculation processing unit 206 of the inquiry about the packet process received from the relay apparatus 101 and topology information.

Note that timing when the path information management unit 205 determines necessity of a process of updating path information is not limited to a case of an inquiry from the relay apparatus 101. For example, the determination of necessity of a process of updating path information may be performed by the path information management unit 205 regularly, and may be performed when receiving information about an unusable relay apparatus from the failure status determination unit 204.

When receiving information about an unusable relay apparatus from the failure status determination unit 204, the path information management unit 205 notifies of deletion of information about a path that uses a port connected to the unusable relay apparatus. The path information management unit 205 notifies, for example, relay apparatuses 101, except the unusable relay apparatus notified from the failure status determination unit 204, of deletion of information about a path that uses a port connected to the unusable relay apparatus, via the relay apparatus communication unit 201. After notifying of deletion of the path information, for example, the path information management unit 205 notifies the path information calculation processing unit 206 of topology information and information about the unusable relay apparatus received from the failure status determination unit 204.

The path information management unit 205 stores and manages, for example, a control command generated by the path control command generation unit 207 in the own flow table. Note that information that the path information management unit 205 stores and manages is not limited the path control command generated by the path control command generation unit 207. The path information management unit 205 may store and manage a forward entry set in the relay apparatus 101 by the relay apparatus communication unit 201, and may store and manage a result of path calculation by the path information calculation processing unit 206.

After receiving a notification of deletion completion of the path information relating to the down port from the relay apparatus 101 via the relay apparatus communication unit 201, for example, the path information management unit 205 instructs a notification of a forward entry of a bypass path. The path information management unit 205 receives, for example, a notification of setting completion of the forward entry of the bypass path from the relay apparatus 101 via the relay apparatus communication unit 201.

The path information calculation processing unit 206 calculates a path for a packet process, based on information notified from the path information management unit 205. The path information calculation processing unit 206 calculates, for example, based on information about an unusable relay apparatus notified from the path information management unit 205 and topology information, a path bypassing the unusable relay apparatus. The path information calculation processing unit 206 calculates, for example, a path between relay apparatuses connected between terminals, and calculates such a delivery-tree path that enables delivery from a relay apparatus directly connected with a terminal for broadcast packet forwarding purpose to all other relay apparatuses. The path information calculation processing unit 206 forwards, for example, a result of the calculation of path information to the path control command generation unit 207.

Note that, when being notified of detection of an unusable relay apparatus from the path information management unit 205, the path information calculation processing unit 206 excludes the unusable relay apparatus from a content of a notification to the path control command generation unit 207 about a result of the calculation of path information, in order to avoid a process of updating the path information for the relay apparatus 101.

The path control command generation unit 207 generates a control command, based on a result of the calculation of path information notified from the path information calculation processing unit 206. The path control command generation unit 207 transmits, for example, a control command to each of the relay apparatuses 101 on the path via the relay apparatus communication unit 201.

[Description of Operation]

Description is given about operation according to the first example embodiment of the present invention with reference to FIGS. 1, 3, 4 and 5.

The control apparatus 200 communicates with a group of the relay apparatuses 101-1, 101-2, 101-3, and 101-4 disposed in the network to be managed 100, via secure channels. The control apparatus 200 centralizedly manages pieces of path information of the relay apparatuses 101 in the network to be managed 100, via the secure channels.

In FIG. 1, when communication is started between the terminal 300-1 and the terminal 300-2, the relay apparatus 101-1 receives a packet issued by the terminal 300-1 that has started the communication.

The relay apparatus 101-1 reads header information (such as transmission-source information and transmission-destination information) of the packet, and searches for a matching flow entry from the own flow table. When a matching flow entry is found as a result of the search, the relay apparatus 101-1 processes the packet in a manner as described in an action of the flow entry. When a matching flow entry is not found as a result of the search, the relay apparatus 101-1 determines the packet as being a “first packet”, and inquires of the control apparatus 200 via the secure channel about a forwarding path.

Note that an operation example of the control apparatus 200 is as follows:

The relay apparatus communication unit 201 receives an inquiry from the relay apparatus 101-1, and forwards the inquiry to the path information management unit 205.

When there is a matching flow entry in the own flow table, the path information management unit 205 forwards the flow entry to the relay apparatus 101-1 via the relay apparatus communication unit 201. When there is no matching flow entry in the own flow table, the path information management unit 205 forwards the inquiry from the relay apparatus 101-1 and topology information and port information acquired from the topology management unit 203 to the path information calculation processing unit 206.

The path information calculation processing unit 206 calculates a bidirectional path for forwarding a packet from the relay apparatus 101-1 to the relay apparatus 101-3, based on information received from the path information management unit 205, and forwards a communication path 401 being a result of the calculation to the path control command generation unit 207.

The path control command generation unit 207 generates a control command, based on the communication path 401 being a result of the calculation by the path information calculation processing unit 206, and forwards the control command to the relay apparatus 101 via the relay apparatus communication unit 201. The path control command generation unit 207 forwards, to the path information management unit 205, a control command of the same content as that forwarded to the relay apparatus 101. The path information management unit 205 stores and manages the control command generated by the path control command generation unit 207. The relay apparatus communication unit 201 converts the notified path control command into a flow entry, and notifies the relay apparatus 101 of the flow entry.

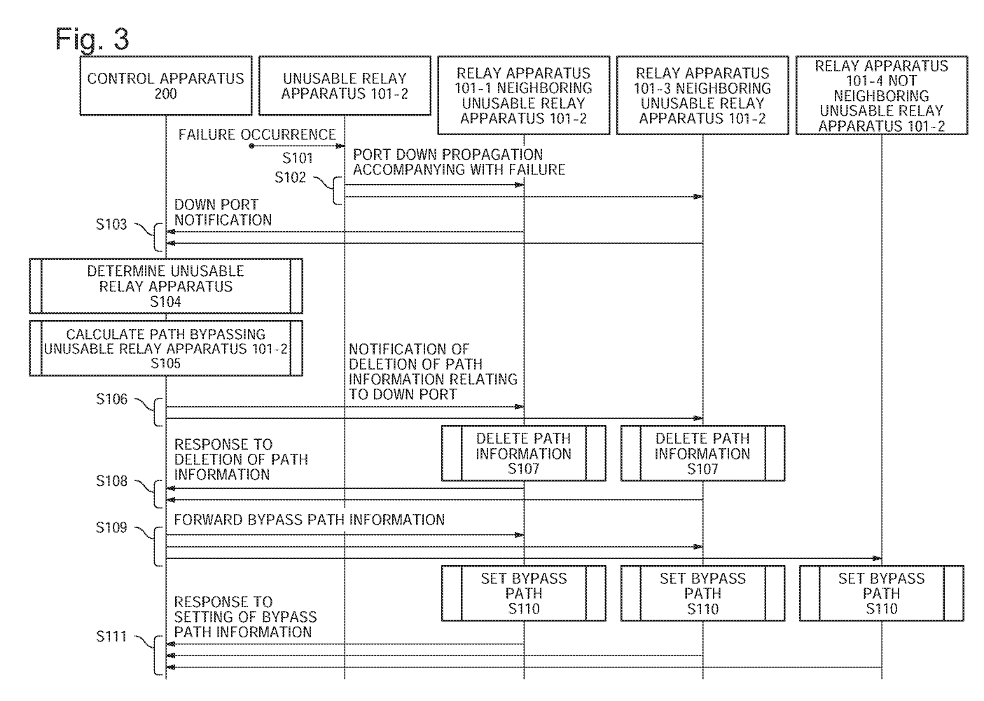

FIG. 3 is a sequence diagram illustrating an operation example performed between the control apparatus 200 and the relay apparatus 101 in the operation environment according to the first example embodiment of the present invention. Note that FIG. 3 is an operation example in a case of a failure occurring at the relay apparatus 101-2.

Assume that, for example, an unexpected power failure occurs at the relay apparatus 101-2 in the network to be managed 100, and the relay apparatus 101-2 becomes unusable (S101).

Due to a fact that the relay apparatus 101-2 becomes unusable, a port down state propagates toward a port #1 of the relay apparatus 101-1 and a port #1 of the relay apparatus 101-3 directly connected with the relay apparatus 101-2 (S102).

The port #1 of the relay apparatus 101-1 and the port #1 of the relay apparatus 101-3 become a down state, and the relay apparatus 101-1 and the relay apparatus 101-3 notify the control apparatus 200 of respective down port notifications (S103).

The control apparatus 200 determines an unusable relay apparatus, based on topology information and port information (S104). The control apparatus 200 determines the relay apparatus 101-2 as being an unusable relay apparatus from a fact that the ports of the neighboring relay apparatuses 101 are all in a down state.

The control apparatus 200 calculates a bidirectional communication path 402 from the relay apparatus 101-1 via the relay apparatus 101-4 to the relay apparatus 101-3, as a path bypassing the unusable relay apparatus 101-2 (S105).

The control apparatus 200 issues a notification of deletion of path information relating to a down port to the relay apparatuses 101-1, 101-3 (S 106).

After receiving the notification of deletion of the path information from the control apparatus 200, the relay apparatus 101-1 and the relay apparatus 101-3 delete the path information relating to the down port (S107).

After completing the deletion of the path information relating to the down port, the relay apparatus 101-1 and the relay apparatus 101-3 notify the control apparatus 200 of the deletion completion (S108).

After receiving the notification of the deletion completion of the path information relating to the down port from the relay apparatus 101-1 and the relay apparatus 101-3, the control apparatus 200 forwards information about the communication path 402 being a bypass path to the relay apparatuses 101-1, 101-3 and 101-4 (S109).

After receiving the information about the communication path 402 from the control apparatus 200, the relay apparatuses 101-1, 101-3 and 101-4 set a flow entry relating to the communication path 402 in the own flow tables (S110).

After completing the setting of the flow entry relating to the communication path 402 in the own flow tables, the relay apparatuses 101-1, 101-3 and 101-4 notify the control apparatus 200 of the setting completion (S111).

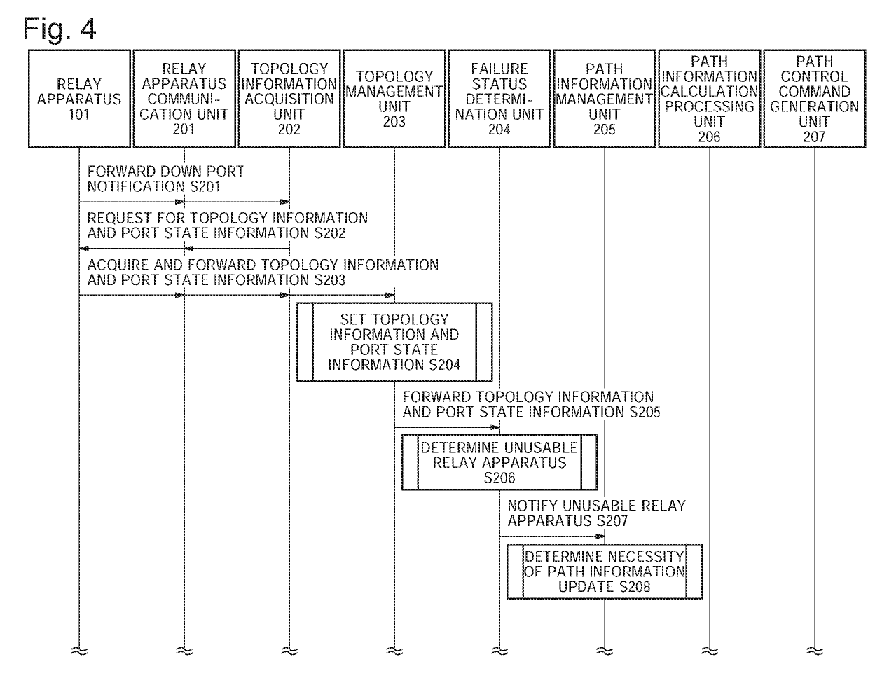

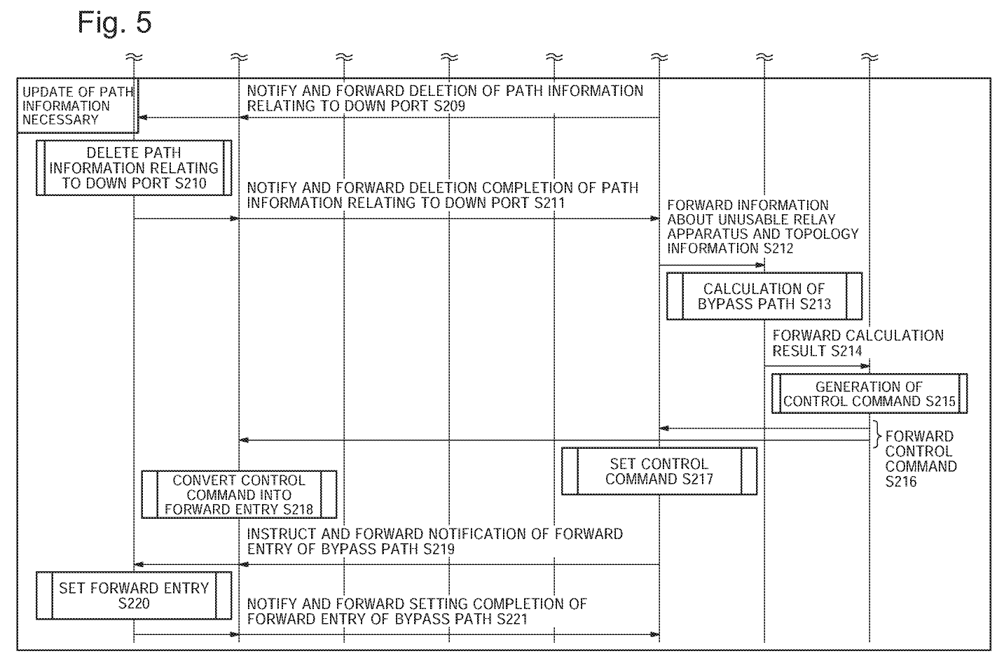

FIGS. 4 and 5 are a sequence diagram illustrating an operation example of the control apparatus 200 according to the first example embodiment of the present invention. Note that FIGS. 4 and 5 are an operation example of the control apparatus 200 in a case of a failure occurring at the relay apparatus 101-2.

The relay apparatus communication unit 201 receives a down port notification from the relay apparatuses 101-1 and 101-3, and forwards the notification to the topology information acquisition unit 202 (S201).

When receiving the down port notification, the topology information acquisition unit 202 requests, from the relay apparatuses 101 in the network to be managed 100 via the relay apparatus communication unit 201, for information about an UP/DOWN state of an own port (port state information) and a connection destination (topology information) (S202).

The relay apparatuses 101-1, 101-3 and 101-4 forward own topology information and port state information to the topology information acquisition unit 202 via the relay apparatus communication unit 201. The topology information acquisition unit 202 forwards the topology information and the port state information acquired from each of the relay apparatuses 101-1, 101-3 and 101-4 to the topology management unit 203 (S203).

The topology management unit 203 sets the topology information in the topology information management unit 203-1 and sets the port state information in the port state management unit 203-2, to set the information (S204).

The topology management unit 203 forwards the topology information and the port information of the relay apparatuses 101 in the network to be managed 100 to the failure status determination unit 204 (S205).

The failure status determination unit 204 determines presence of a relay apparatus neighboring relay apparatuses whose ports are all in a down state, based on the topology information in the topology information management unit 203-1 and the port state information in the port state management unit 203-2. The failure status determination unit 204 determines the relay apparatus 101-2 neighboring relay apparatuses whose ports are all in a down state, as being an unusable relay apparatus (S206).

The failure status determination unit 204 notifies the path information management unit 205 of a fact that the relay apparatus 101-2 is unusable (S207). After receiving the notification that the relay apparatus 101-2 is unusable from the failure status determination unit 204, the path information management unit 205 determines necessity of updating the communication path 401 in use for communication between the terminal 300-1 and the terminal 300-2 (S208).

When determining that updating the communication path 401 is necessary, the path information management unit 205 issues a notification of deletion of path information relating to a down port to the relay apparatuses 101-1, 101-3 via the relay apparatus communication unit 201 (S209).

The relay apparatus 101-1 and the relay apparatus 101-3 receive the notification of deletion of the path information from the path information management unit 205 via the relay apparatus communication unit 201, and delete the path information relating to the down port in accordance with the notification (S210).

After completing the deletion of the path information relating to the down port, the relay apparatus 101-1 and the relay apparatus 101-3 notify the path information management unit 205 of the deletion completion via the relay apparatus communication unit 201 (S211).

The path information management unit 205 forwards information about the relay apparatus that becomes unusable (a fact that the relay apparatus 101-2 is unusable) and topology information acquired from the topology management unit 203 to the path information calculation processing unit 206 (S212).

The path information calculation processing unit 206 calculates, based on the information received from the path information management unit 205, a bidirectional communication path 402 from the relay apparatus 101-1 via the relay apparatus 101-4 to the relay apparatus 101-3, as a path bypassing the relay apparatus 101-2 (S213).

The path information calculation processing unit 206 forwards information about the communication path 402 calculated as a path bypassing the relay apparatus 101-2 to the path control command generation unit 207 (S214).

The path control command generation unit 207 generates a control command for the communication path 402 received from the path information calculation processing unit 206 (S215).

The path control command generation unit 207 forwards the generated control command to the path information management unit 205 and the relay apparatus communication unit 201 (S216).

The path information management unit 205 sets the control command received from the path control command generation unit 207 in the own flow table (S217).

The relay apparatus communication unit 201 converts the control command received from the path control command generation unit 207 into a forward entry (S218).

After setting the control command received from the path control command generation unit 207 in the own flow table, the path information management unit 205 forwards a forward entry of the communication path 402 calculated by the path information calculation processing unit 206 to the relay apparatuses 101 via the relay apparatus communication unit 201 (S219).

The relay apparatuses 101-1, 101-3 and the relay apparatus 101-4 set, in the own flow tables, the forward entry received from the path information management unit 205 via the relay apparatus communication unit 201 (S220). After setting the forward entry in the own flow tables, the relay apparatuses 101-1, 101-3 and the relay apparatus 101-4 notify the path information management unit 205 of the setting completion via the relay apparatus communication unit 201 (S221).

Note that, in the control apparatus 200, a notification of deletion of path information relating to a down port (S209) may be executed after a bypass path is calculated (S213), and may be concurrently executed.

[Description of Effect]

In the first example embodiment of the present invention, as described above, when a part of the relay apparatuses in the network becomes unusable, the control apparatus detects an unusable relay apparatus, based on topology information and down port notifications of all apparatuses neighboring the unusable relay apparatus. The control apparatus sets, for relay apparatuses other than the unusable relay apparatus, a communication path bypassing the unusable relay apparatus. This can shorten a time during which user traffic is stopped flowing between the terminals while waiting for a response time-out (a communication breakdown time), since there is no need of waiting for a time-out of a response from the unusable relay apparatus.

In addition, by setting the communication path bypassing the unusable relay apparatus for the relay apparatuses other than the unusable relay apparatus, the communication path can be set without waiting for a time-out of a response from the unusable relay apparatus. This can shorten a time for the setting of the communication path bypassing the unusable relay apparatus.

### Second Example Embodiment

[Description of Configuration]

A second example embodiment of the present invention is described in detail with reference to the drawings. Note that a technique in the second example embodiment is applicable to both of the first example embodiment and an example embodiment to be described later.

A configuration example of an operation environment according to the second example embodiment is the same as the configuration example of the operation environment according to the first example embodiment exemplified in FIG. 1, and hence, detailed description is omitted.

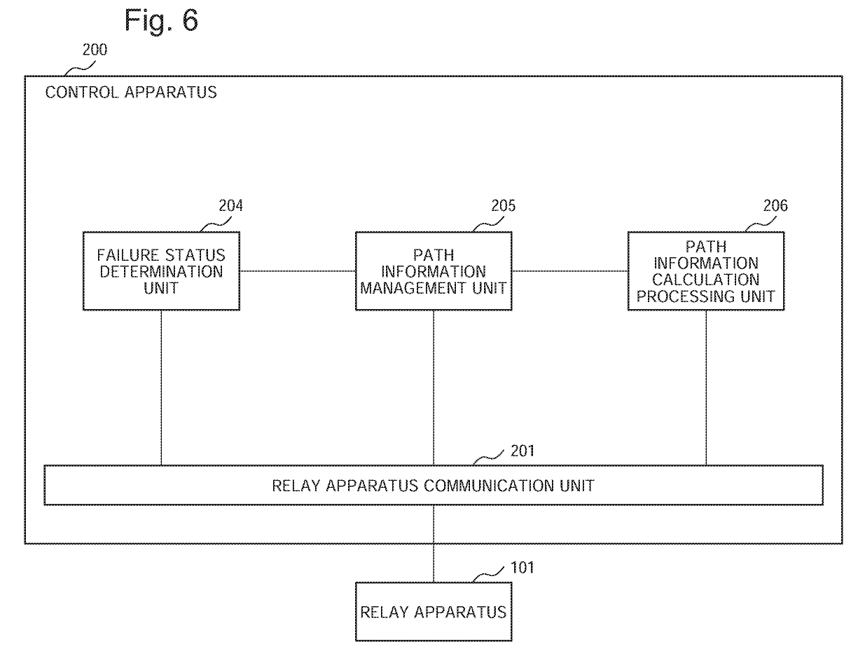

FIG. 6 is a diagram illustrating a configuration example of a control apparatus 200 according to the second example embodiment of the present invention. In the second example embodiment of the present invention, as illustrated in FIG. 6, the control apparatus 200 includes a relay apparatus communication unit 201, a failure status determination unit 204, a path information management unit 205, and a path information calculation processing unit 206.

The relay apparatus communication unit 201 performs establishment of a session for control and transmission and reception of a command for control for each of the relay apparatuses 101 connected in the network to be managed 100, via a secure channel.

The relay apparatus communication unit 201 receives, for example, an inquiry about a packet process from the relay apparatus 101, and forwards the inquiry to the path information management unit 205. When there is a description of the packet process in a flow table of the path information management unit 205, for example, the relay apparatus communication unit 201 forwards information about the packet process described in the flow table of the path information management unit 205 to the relay apparatus 101.

The relay apparatus communication unit 201 receives, for example, from the relay apparatus 101, a notification of a port that became unusable (a down port notification) among ports of the relay apparatuses 101.

The relay apparatus communication unit 201 receives, for example, topology information indicating a connection relationship among the relay apparatuses 101 in the network to be managed 100 and port information indicating an UP/DOWN state of each of the ports in the network to be managed 100. The relay apparatus communication unit 201 forwards, for example, the topology information and the port information to the failure status determination unit 204. Note that the topology information and the port information may be forwarded directly to the path information management unit 205.

The relay apparatus communication unit 201 receives, for example, a notification of deletion of path information relating to a down port from the path information management unit 205, and forwards the notification to the relay apparatus 101. The relay apparatus communication unit 201 receives, for example, a notification of deletion completion of the path information relating to the down port from the relay apparatus 101, and forwards the notification to the path information management unit 205.

The relay apparatus communication unit 201 receives, for example, a communication path calculated by the path information calculation processing unit 206, generates a forward entry for appropriately delivering a unicast packet, a broadcast packet, and the like to a forwarding table, and forwards the forward entry to the relay apparatus 101. Note that generation of a forward entry is performed not only by the relay apparatus communication unit 201, but may be performed by the path information calculation processing unit 206 and the path information management unit 205.

The relay apparatus communication unit 201 receives, for example, a notification of setting completion of the forward entry from the relay apparatus 101, and forwards the notification to the path information management unit 205.

The failure status determination unit 204 determines whether an unusable relay apparatus 101 is present. The failure status determination unit 204 references, for example, topology information and port state information received from the relay apparatus 101 via the relay apparatus communication unit 201, and determines presence of a relay apparatus 101 neighboring relay apparatuses whose ports are all in a down state. When a relay apparatus 101 pertaining to the condition is present, the failure status determination unit 204 determines the relay apparatus 101 as being an unusable relay apparatus, and notifies the path information management unit 205 of a fact that the relay apparatus 101 is unusable.

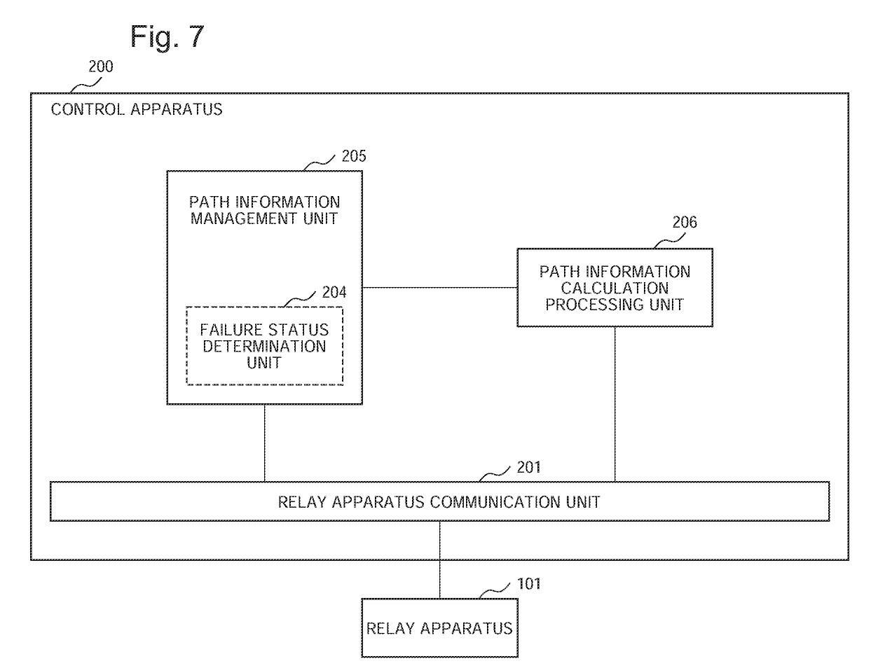

Note that the failure status determination unit 204 may be implemented as a function of the path information management unit 205, as in, for example, FIG. 7.

The path information management unit 205 determines whether a process of updating path information is necessary or not. In response to an inquiry about a packet process from the relay apparatus 101, for example, when there is a description of the packet process in the own flow table, the path information management unit 205 forwards information about the packet process to the relay apparatus 101 via the relay apparatus communication unit 201. When there is no description of the packet process in the own flow table, for example, the path information management unit 205 notifies the path information calculation processing unit 206 of the inquiry about the packet process received from the relay apparatus 101 and topology information.

Note that timing when the path information management unit 205 determines necessity of a process of updating path information is not limited to a case of an inquiry from the relay apparatus 101. For example, the determination may be performed regularly, and may be performed when receiving information about an unusable relay apparatus from the failure status determination unit 204.

When receiving information about an unusable relay apparatus from the failure status determination unit 204, the path information management unit 205 notifies of deletion of information about a path that uses a port connected to the unusable relay apparatus. The path information management unit 205 notifies, for example, relay apparatuses 101, except the unusable relay apparatus notified from the failure status determination unit 204, of deletion of information about a path that uses a port connected to the unusable relay apparatus, via the relay apparatus communication unit 201. After notifying of deletion of the path information, for example, the path information management unit 205 notifies the path information calculation processing unit 206 of topology information and information received from the failure status determination unit 204.

The path information management unit 205 receives a communication path calculated by the path information calculation processing unit 206, and stores and manages the communication path in the own flow table. Note that information that the path information management unit 205 stores and manages is not limited to a result calculated by the path information calculation processing unit 206. The path information management unit 205 may store and manage a forward entry set in the relay apparatus 101 by the relay apparatus communication unit 201.

After receiving a notification of deletion completion of the path information relating to the down port from the relay apparatus 101 via the relay apparatus communication unit 201, for example, the path information management unit 205 instructs a notification of a forward entry of a bypass path. The path information management unit 205 receives, for example, a notification of setting completion of the forward entry of the bypass path from the relay apparatus 101 via the relay apparatus communication unit 201.

The path information calculation processing unit 206 calculates a path for a packet process, based on information notified from the path information management unit 205. The path information calculation processing unit 206 calculates, for example, based on information about an unusable relay apparatus notified from the path information management unit 205 and topology information, a path bypassing the unusable relay apparatus. The path information calculation processing unit 206 calculates, for example, a path between relay apparatuses connected between terminals, and calculates such a delivery-tree path that enables delivery from a relay apparatus directly connected with a terminal for broadcast packet forwarding purpose to all other relay apparatuses. The path information calculation processing unit 206 forwards, for example, a result of the calculation of path information to the relay apparatus communication unit 201.

Note that, when being notified of detection of an unusable relay apparatus from the path information management unit 205, the path information calculation processing unit 206 excludes the unusable relay apparatus from a content of a notification to the relay apparatus communication unit 201 about a result of the calculation of path information, in order to avoid a process of updating the path information for the relay apparatus 101.

[Description of Operation]

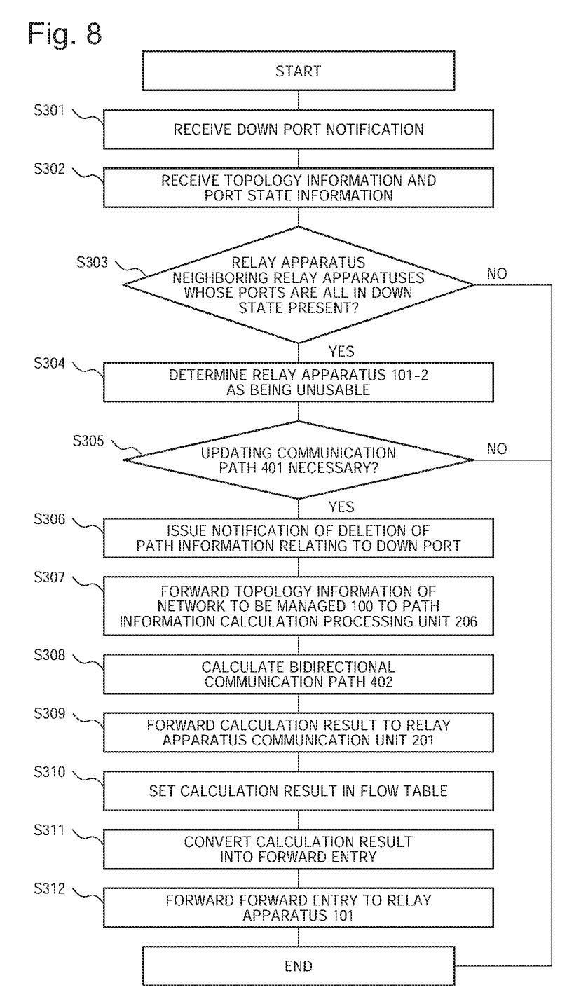

Description is given about operation according to the second example embodiment of the present invention with reference to FIGS. 1, 6, and 8.

A configuration example of an operation environment according to the second example embodiment is the same as the configuration example of the operation environment according to the first example embodiment exemplified in FIG. 1, and hence, detailed description is omitted. In addition, an operation example performed between the control apparatus 200 and the relay apparatus 101 in the operation environment according to the second example embodiment of the present invention is the same as the operation example performed between the control apparatus 200 and the relay apparatus 101 exemplified in FIG. 3, and hence, detailed description is omitted.

The relay apparatus communication unit 201 receives a down port notification from the relay apparatuses 101-1 and 101-3 (S301).

The relay apparatus communication unit 201 forwards topology information and port state information of each of the relay apparatuses 101-1, 101-3, and 101-4 to the failure status determination unit 204 (S302).

The failure status determination unit 204 determines presence of a relay apparatus neighboring relay apparatuses whose ports are all in a down state, based on the topology information and the port state information received from each of the relay apparatuses 101-1, 101-3, and 101-4 (S303).

The failure status determination unit 204 notifies the path information management unit 205 of a fact that the relay apparatus 101-2 is unusable (S304).

After receiving the notification that the relay apparatus 101-2 is unusable from the failure status determination unit 204, the path information management unit 205 determines necessity of updating the communication path 401 in use for communication between the terminal 300-1 and the terminal 300-2 (S305).

When determining that updating the communication path 401 is necessary, the path information management unit 205 issues a notification of deletion of path information relating to a down port to the relay apparatuses 101-1, 101-3 via the relay apparatus communication unit 201 (S306).

Note that, in this case, the relay apparatus 101-1 and the relay apparatus 101-3 receive the notification of deletion of path information from the path information management unit 205 via the relay apparatus communication unit 201, and delete the path information relating to the down port in accordance with the notification. After completing the deletion of the path information relating to the down port, the relay apparatus 101-1 and the relay apparatus 101-3 notify the path information management unit 205 of the deletion completion via the relay apparatus communication unit 201.

The path information management unit 205 forwards information about the relay apparatus that became unusable (a fact that the relay apparatus 101-2 is unusable) and topology information of the network to be managed 100 to the path information calculation processing unit 206 (S307).

The path information calculation processing unit 206 calculates, based on the information received from the path information management unit 205, a bidirectional communication path 402 from the relay apparatus 101-1 via the relay apparatus 101-4 to the relay apparatus 101-3, as a path bypassing the relay apparatus 101-2 (S308).

The path information calculation processing unit 206 forwards information about the communication path 402 calculated as a path bypassing the relay apparatus 101-2 to the path information management unit 205 and the relay apparatus communication unit 201 (S309).

The path information management unit 205 sets a result of the path calculation by the path information calculation processing unit 206 in the own flow table (S310).

The relay apparatus communication unit 201 converts a result of the path calculation received from the path information calculation processing unit 206 into a forward entry (S311).

After setting the result of the path calculation received from the path information calculation processing unit 206 in the own flow table, the path information management unit 205 forwards a forward entry of the communication path 402 calculated by the path information calculation processing unit 206 to the relay apparatus 101 via the relay apparatus communication unit 201 (S312).

Note that the relay apparatuses 101-1, 101-3, and the relay apparatus 101-4 set, in the own flow tables, the forward entry received from the path information management unit 205 via the relay apparatus communication unit 201. After setting the forward entry in the own flow tables, the relay apparatuses 101-1, 101-3, and the relay apparatus 101-4 notify the path information management unit 205 of setting completion via the relay apparatus communication unit 201.

Note that, in the control apparatus 200, a notification of deletion of path information relating to a down port (S306) may be executed after a bypass path is calculated (S310), and may be concurrently executed.

[Description of Effect]

In the second example embodiment of the present invention, as described above, when a part of the relay apparatuses in the network becomes unusable, the control apparatus detects an unusable relay apparatus, based on topology information and down port notifications of all relay apparatuses neighboring the unusable relay apparatus. The control apparatus sets, for relay apparatuses other than the unusable relay apparatus, a communication path bypassing the unusable relay apparatus. This can shorten a time during which user traffic is stopped flowing between the terminals while waiting for a response time-out (a communication breakdown time), since there is no need of waiting for a time-out of a response from the unusable relay apparatus.

In addition, by setting the communication path bypassing the unusable relay apparatus for the relay apparatuses other than the unusable relay apparatus, the communication path can be set without waiting for a time-out of a response from the unusable relay apparatus. This can shorten a time for the setting of the communication path bypassing the unusable relay apparatus.

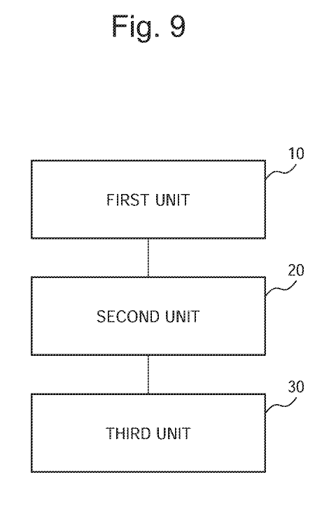

The control apparatus of the present invention can be also configured as in FIG. 9. The control apparatus in FIG. 9 is a control apparatus capable of controlling a plurality of relay apparatuses capable of executing a process for a packet. The control apparatus in FIG. 9 includes a first unit 10, a second unit 20, and a third unit 30. The first unit 10 determines presence of a predetermined relay apparatus in a state incommunicable with all neighboring relay apparatuses. The second unit 20 calculates a communication path bypassing the predetermined relay apparatus as a communication path for the packet when determined that the predetermined relay apparatus is present. The third unit 30 notifies at least one of the plurality of relay apparatuses of a processing rule for achieving the calculated communication path.

By using the control apparatus as in FIG. 9, a communication path bypassing a relay apparatus in a state incommunicable with all neighboring relay apparatuses can be calculated by the second unit 20, and the other relay apparatuses can be notified of a processing rule based on the calculated communication path. Consequently, by using the control apparatus as in FIG. 9, a communication breakdown time generated when a relay apparatus becomes unusable can be shortened. In addition, the communication system can be also configured by including the control apparatus in FIG. 9 and a plurality of relay apparatuses executing a process for a packet.

In addition, the technique according to each of the example embodiments of the present invention is applicable to a technical field of a software-defined network (SDN).

In addition, a computer, a central processing unit (CPU), a micro-processing unit (MPU), or the like in the control apparatus and the relay apparatus in the present invention may execute software (program) achieving the function of each of the above-described example embodiments. The computer, the CPU, the MPU, or the like in the control apparatus and the relay apparatus may acquire software (program) achieving the function of each of the above-described example embodiments, via a variety of storage media, such as a compact disc recordable (CD-R), or a network. A program that the control apparatus and the relay apparatus acquire and a storage medium that stores the program result in configuring the present invention. Note that the software (program) may be stored in advance, for example, in a predetermined storage unit included in the control apparatus and the relay apparatus. The computer, the CPU, the MPU, or the like in the control apparatus and the relay apparatus may execute the acquired software (program) by reading a program code of the software (program).

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A control apparatus capable of controlling a plurality of relay apparatuses capable of executing a process for a packet,
the control apparatus comprising:
a first unit that determines presence of a predetermined relay apparatus in a state incommunicable with all neighboring relay apparatuses;
a second unit that calculates a communication path bypassing the predetermined relay apparatus as a communication path for the packet, when it is determined that the predetermined relay apparatus is present; and
a third unit that notifies at least one of the plurality of relay apparatuses of a processing rule for achieving the calculated communication path.

2. The control apparatus according to claim 1, wherein the first unit determines presence of a predetermined relay apparatus whose ports are all in a down state.

3. The control apparatus according to claim 1, wherein the first unit determines presence of the predetermined relay apparatus, based on information relating to a port state notified from a relay apparatus neighboring the predetermined relay apparatus.

4. The control apparatus according to claim 1, wherein the second unit calculates a communication path bypassing the predetermined relay apparatus, by using topology information from which information relating to the predetermined relay apparatus is deleted.

5. The control apparatus according to claim 1, wherein the second unit calculates a communication path bypassing the predetermined relay apparatus, by using topology information from which information relating to a port in a down state included in the predetermined relay apparatus is deleted.

6. The control apparatus according to claim 1, wherein the second unit determines whether updating a communication path for the packet is necessary, when it is determined that the predetermined relay apparatus is present, and calculates a communication path bypassing the predetermined relay apparatus in response to determination that the updating is necessary.

7. A communication system comprising:
a plurality of relay apparatuses executing a process for a packet; and
a control apparatus capable of controlling the relay apparatuses, wherein the control apparatus comprises:
a first unit that determines presence of a predetermined relay apparatus in a state of communication breakdown with all neighboring relay apparatuses;
a second unit that calculates a communication path bypassing the predetermined relay apparatus as a communication path for the packet, when it is determined that the relay apparatus is present; and
a third unit that notifies at least one of the plurality of relay apparatuses of a processing rule for achieving the calculated communication path.

8. A control method for a control apparatus capable of controlling a plurality of relay apparatuses executing a process for a packet, the control method comprising the steps of:
determining presence of a predetermined relay apparatus in a state incommunicable with all neighboring relay apparatuses;
calculating a communication path bypassing the predetermined relay apparatus as a communication path for the packet, when it is determined that the predetermined relay apparatus is present; and
notifying at least one of the plurality of relay apparatuses of a processing rule for achieving the calculated communication path.

9. The control method according to claim 8, further comprising the step of determining presence of a predetermined relay apparatus whose ports are all in a down state.

10. The control method according to claim 8, further comprising the step of determining presence of the predetermined relay apparatus, based on information relating to a port state notified from a relay apparatus neighboring the predetermined relay apparatus.

11. The control method according to claim 8, further comprising the step of calculating a communication path bypassing the predetermined relay apparatus, by using topology information from which information relating to the predetermined relay apparatus is deleted.

12. The control method according to claim 8, further comprising the step of calculating a communication path bypassing the predetermined relay apparatus, by using topology information from which information relating to a port in a down state included in the predetermined relay apparatus is deleted.

13. The control method according to claim 8, further comprising the step of determining whether updating a communication path for the packet is necessary, when it is determined that the predetermined relay apparatus is present, and calculates a communication path bypassing the predetermined relay apparatus in response to determination that the updating is necessary.
